(19) United States
(12) Patent Application Publication
(10) Pub. No.: US 2022/0158215 A1
(43) Pub. Date: May 19, 2022

(54) HIGH ENERGY DENSITY CHARGE-DISCHARGE BATTERY

(71) Applicant: NINGBO XIXIANGSHI NEW ENERGY CO., LTD., NINGBO (CN)

(72) Inventor: SHEN ZHOU, NINGBO (CN)

(21) Appl. No.: 17/588,286

(22) Filed: Jan. 30, 2022

(30) Foreign Application Priority Data
Feb. 7, 2021 (CN) 2021203474490

(51) Int. Cl. H01M 8/18; H01M 4/38; H01M 8/08

(52) U.S. Cl. CPC H01M 8/188; H01M 2004/027; H01M 8/08; H01M 4/382

(57) ABSTRACT

The present utility model relates to the technical field of battery devices, and in particular to a high energy density charge-discharge battery. One end of an anode is arranged in a first electrolyte chamber, and one end of a first cathode is arranged in a second electrolyte chamber. The first electrolyte chamber, a buffer electrolyte mechanism and the second electrolyte chamber are sequentially connected. According to the present application, the cost of battery electrodes is reduced, the energy density of rechargeable batteries is improved, and the service life of rechargeable batteries is prolonged.

### TECHNICAL FIELD

The present utility model relates to the technical field of battery devices, and in particular to a high energy density charge-discharge battery.

### BACKGROUND

The existing high energy density rechargeable battery technology adopts the structure of one diaphragm and two electrolyte chambers, and the anode and the cathode are located in each one electrolyte chamber and separated by a diaphragm. The structure of the electrolyte chambers greatly limits the selection of materials of the cathode and the anode, resulting in increased battery mass and reduced energy density, and limitations in electrode materials also greatly reduce the service life of rechargeable batteries.

The most common high energy batteries on the market are lithium-ion batteries. Lithium batteries are a kind of batteries that use lithium metal or lithium alloy as the material of the anode and use a non-aqueous electrolyte solution, having the maximum energy density about 250 wh/kg. Due to highly active chemical properties of lithium metal, the processing, storage and use of lithium metal have very high environmental requirements. Therefore, lithium batteries have not been applied for a long time. With the development of science and technology, people continue to study lithium batteries, and lithium battery technology becomes increasingly mature. Lithium batteries have a series of advantages, such as strong high and low temperature adaptability, very low self-discharge rates, high rated voltage, and environmental friendliness. Lead, mercury, cadmium, and other toxic and harmful heavy metal elements and substances are contained or generated in none of the production, use and disposal, which makes the current lithium batteries the mainstream.

However, one limitation of lithium-ion batteries is that the materials of the cathode are mainly composed of cobalt, manganese, nickel, and other metal oxides, which are of large mass, high costs, and short service life. Therefore, the materials of the cathode have been one of the factors restricting the energy density of lithium-ion batteries.

Therefore, how to improve the capacity density of lithium batteries and expand the selectivity of materials of cathodes has always been a technical problem that a person skilled in the art needs to solve urgently.

### SUMMARY

The first object of the present utility model is to provide a high energy density charge-discharge battery, which expands the selection range of materials of the anode and cathode, and reduces the cost of battery electrodes.

The present application provides a high energy density charge-discharge battery, comprising: an anode, a first cathode, a first electrolyte chamber, a second electrolyte chamber, and a buffer electrolyte mechanism.

One end of the anode is arranged in the first electrolyte chamber, and one end of the first cathode is arranged in the second electrolyte chamber.

The first electrolyte chamber, the buffer electrolyte mechanism and the second electrolyte chamber are sequentially connected, a first ion exchange membrane is provided between the first electrolyte chamber and the buffer electrolyte mechanism, and a second ion exchange membrane with opposite polarity to the first ion exchange membrane is provided between the buffer electrolyte mechanism and the second electrolyte chamber.

Further, the buffer electrolyte mechanism comprises a plurality of buffer electrolyte chambers that are sequentially connected in series. One side of each buffer electrolyte chamber is also provided with the first ion exchange membrane, and the other side of each buffer electrolyte chamber is also provided with the second ion exchange membrane. The first buffer electrolyte chamber and the first electrolyte chamber are connected by means of the first ion exchange membrane, and the first ion exchange membrane is a negative ion exchange membrane. The last buffer electrolyte chamber and the second electrolyte chamber are connected by means of a second ion exchange membrane, and the second ion exchange membrane is a positive ion exchange membrane.

Further, the buffer electrolyte mechanism further comprises a hydrolysis neutralization chamber, and a second cathode is provided in the hydrolysis neutralization chamber. The last buffer electrolyte chamber is connected to the hydrolysis neutralization chamber, and the positive ion exchange membrane is disposed between the two. The negative ion exchange membrane is disposed between the hydrolysis neutralization chamber and the second electrolyte chamber.

Further, the electrolyte in each buffer electrolyte chamber is an acidic solution that can ionize H⁺.

Further, the electrolyte in the second electrolyte chamber is an alkali metal solution.

Further, the material of the anode is lithium metal.

Further, the materials of the first cathode and the second cathode are both oxygen.

Further, the positive ion exchange membrane is a fluorosulfuric acid proton exchange membrane.

The present utility model also discloses a charge-discharge method for the charge-discharge battery mentioned above, the method comprising a discharging process and a charging process. During the discharging process, H⁺ is used in place of metal ions released from the anode to be bonded to the material of the cathode. During the charging process, the buffer electrolyte mechanism is used to prevent H⁺ from migrating to a first electrolysis chamber.

Further, the discharging process comprises: electrons flow from the anode to the first cathode, and the material of the anode in the first electrolysis chamber loses electrons to obtain a first positive ion; the electrolyte in the buffer electrolyte chamber is ionized to obtain a first negative ion and H⁺; and the material of the first cathode in a second electrolysis chamber obtains electrons to be bonded to H⁺.

The first negative ion enters the first electrolyte chamber through the negative ion exchange membrane, and H⁺ enters the second electrolyte chamber through the positive ion exchange membrane to be bonded to the material of the first cathode in place of the first positive ion.

The charging process comprises: electrons flow from the first cathode to the anode, molecules in the second electrolyte chamber lose H⁺ obtained by electron decomposition, and the electrolyte in the first electrolyte chamber is ionized to obtain a first positive ion and a first negative ion.

The first positive ion accepts electrons to become the material of the anode, and H⁺ and the first negative ion enter the buffer electrolyte chamber respectively through the positive ion exchange membrane and the negative ion exchange membrane and are bonded.

Further, the discharging process comprises: electrons flow from the anode to the first cathode, and the material of the anode in the first electrolyte chamber loses electrons to obtain a first positive ion; the electrolyte in the buffer electrolyte chamber is ionized to obtain a first negative ion and H⁺; and the material of the first cathode in the second electrolyte chamber obtains electrons to generate OH⁻.

H⁺ and OH⁻ respectively enter the hydrolysis neutralization chamber through the positive ion exchange membrane and the negative ion exchange membrane to generate water molecules, and the first negative ion enters the first electrolyte chamber through the negative ion exchange membrane to be bonded to the first positive ion.

The charging process comprises: electrons flow from the second cathode to the anode, and molecules in the hydrolysis neutralization chamber lose electrons to obtain H⁺; and the electrolyte in the first electrolyte chamber is ionized to obtain a first positive ion and a first negative ion.

The first positive ion accepts electrons to become the material of the anode, and H⁺ and the first negative ion enter the buffer electrolyte chamber respectively through the positive ion exchange membrane and the negative ion exchange membrane and are bonded.

Compared with the prior art, the high energy density charge-discharge battery according to the present utility model has the following advantages.

The high energy density charge-discharge battery of the present utility model comprises an anode, a cathode, a first electrolyte chamber, a second electrolyte chamber and a buffer electrolyte mechanism. The first electrolyte chamber, the buffer electrolyte mechanism and the second electrolyte chamber are sequentially connected. A negative ion exchange membrane provided between the first electrolyte chamber and the buffer electrolyte mechanism only allows negative ions to pass through. A positive ion exchange membrane is provided between the buffer electrolyte mechanism and the second electrolyte chamber to allow negative ions to pass through. During the discharging process of the charge-discharge battery, electrons flow from the anode to the first cathode, the material of the anode in the first electrolyte chamber loses electrons to obtain a first positive ion, and the electrolyte in the buffer electrolyte chamber is ionized to obtain a first negative ion and H⁺. The material of the first cathode in the second electrolyte chamber obtains electrons to be bonded to H+. The first negative ion enters the first electrolyte chamber through the negative ion exchange membrane, and H+ enters the second electrolyte chamber through the positive ion exchange membrane to be bonded to the material of the first cathode in place of the first positive ion. Therefore, during the discharging process, H⁺ is bonded to the material of the first cathode in place of the first positive ion, thereby effectively preventing the first positive ion generated at the anode from migrating to the surface of the material of the first cathode. During the charging process, electrons flow from the first cathode to the anode, molecules in the second electrolyte chamber lose H+ obtained by electron decomposition, and the electrolyte in the first electrolyte chamber is ionized to obtain a first positive ion and a first negative ion. The first positive ion accepts electrons to become the material of the anode, and H⁺ and the first negative ion enter the buffer electrolyte chamber respectively through the positive ion exchange membrane and the negative ion exchange membrane and are bonded. Therefore, during the discharging process, the H⁺ generated in the second electrolyte chamber is cleverly used to be bonded to the first cathode material in place of the first positive ion generated from the material of the anode to combine into new molecules. The buffer electrolyte mechanism is used to prevent the first positive ion from being mixed with H⁺, thereby avoiding generation of undesired materials of the anode during the charging process. In summary, according to the charge-discharge battery of the present utility model, metal ions generated at the anode are prevented from being directly bonded to the material of the cathode, but instead the second positive ion H⁺ is used to be bonded to the material of the cathode, thereby expanding the selection range of materials of the cathode and anode, reducing the cost of battery electrodes, improving the energy density of rechargeable batteries, and extending the service life of rechargeable batteries.

### BRIEF DESCRIPTION OF THE DRAWINGS

To illustrate the specific embodiments of the present utility model or technical solutions in the prior art more clearly, the following briefly introduces the accompanying drawings required for describing the specific embodiments or the prior art. Obviously, the accompanying drawings in the following description show some embodiments of the present utility model, and for a person of ordinary skill in the art, other accompanying drawings can also be obtained according to these accompanying drawings without creative efforts.

FIG. 1 is a schematic structural diagram of the high energy density charge-discharge battery according to the present utility model;

FIG. 2 is a schematic structural diagram of the high energy density charge-discharge battery with further details based on FIG. 1;

FIG. 3 is a schematic diagram of the discharging process of the high energy density charge-discharge battery according to the present utility model; and

FIG. 4 is a schematic diagram of the charging process of the high energy density charge-discharge battery according to the present utility model.

Reference number listing:

1: anode; 2: first cathode; 3: second cathode; 4: first electrolyte chamber; 5: second electrolyte chamber; 6: buffer electrolyte mechanism; 7: buffer electrolyte chamber; 8: negative ion exchange membrane; 9: positive ion exchange membrane; and 10: hydrolysis neutralization chamber.

### DETAILED DESCRIPTION

The technical solutions of the present utility model will be clearly and completely described with reference to the embodiments. Obviously, the described embodiments are some rather than all of the embodiments of the present utility model. All other embodiments obtained by a person of ordinary skill in the art based on the embodiments of the present utility model without creative efforts shall fall within the protection scope of the present utility model.

In the description of the present utility model, it needs to be understood that orientation or location relationships indicated by the terms such as “center”, “longitudinal”, “transverse”, “length”, “width”, “thickness”, “up”, “down”, “front”, “rear”, “left”, “right”, “vertical”, “horizontal”, “top”, “bottom”, “inside”, “outside”, “clockwise” and “counterclockwise” are based on orientation or location relationships shown in the accompanying drawings, and are only used for facilitating describing the present utility model and simplifying the description, rather than indicating or implying that the referred apparatuses or elements must have specific orientations and are constructed and operated in a specific orientation. Therefore, it should not be understood as a limitation to the present utility model.

In addition, the terms “first” and “second” are used only for description, but should not be understood as indicating or implying relative importance or implicitly specifying the number of indicated technical features. Therefore, features defined as “first” and “second” may explicitly or implicitly include one or more said features. In the description of the present utility model, “a plurality of” herein means two or more, unless otherwise clearly and specifically defined. In addition, the terms “installed”, “connected” and “connection” should be understood in a broad sense, for example, it may be a fixed connection, a detachable connection or an integral connection; may be a mechanical connection or an electrical connection; and may be a direct connection, an indirect connection through an intermediate medium, or an internal communication of two elements. For a person of ordinary skill in the art, specific meanings of the terms mentioned above in the present utility model can be understood according to specific situations.

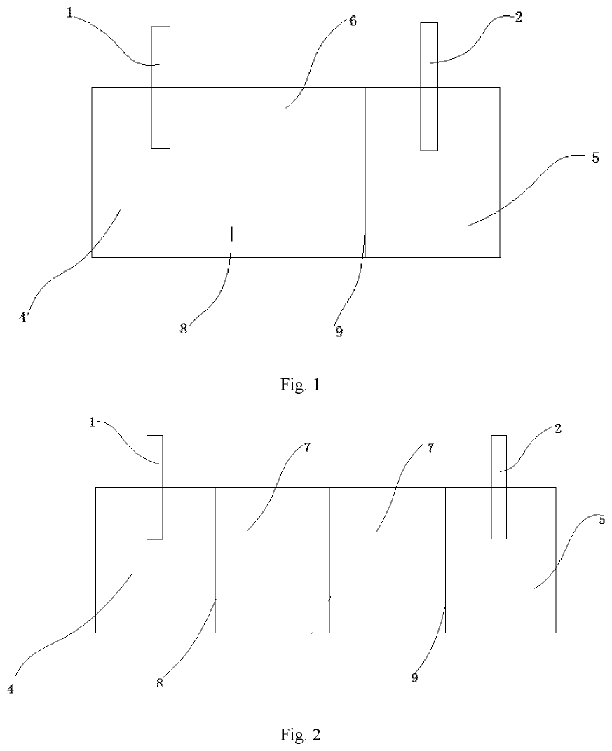

As shown in FIGS. 1-2, the present utility model provides a high energy density charge-discharge battery, comprising an anode 1, a first cathode 2, a first electrolyte chamber 4, a second electrolyte chamber 5 and a buffer electrolyte mechanism 6. One end of the anode 1 is arranged in the first electrolyte chamber 4, and one end of the first cathode 2 is arranged in the second electrolyte chamber 5. The first electrolyte chamber 4, the buffer electrolyte mechanism 6 and the second electrolyte chamber 5 are sequentially connected, a negative ion exchange membrane 8 is provided between the first electrolyte chamber 4 and the buffer electrolyte mechanism 6, and a positive ion exchange membrane 9 is provided between the buffer electrolyte mechanism 6 and the second electrolyte chamber 5.

In the prior art, a high energy density charge-discharge battery usually adopts the structure of one diaphragm and two electrolyte chambers, and the anode and the cathode are located in each one electrolyte chamber and separated by a diaphragm. The structure of the electrolyte chambers greatly limits the selection of materials of the cathode and the anode, resulting in increased battery mass and reduced energy density, and limitations in electrode materials also greatly reduce the service life of rechargeable batteries. In view of the problem, the present utility model provides a high energy density charge-discharge battery, comprising an anode 1, a first cathode 2, a first electrolyte chamber 4, a second electrolyte chamber 5 and a buffer electrolyte mechanism 6. The first electrolyte chamber 4, the buffer electrolyte mechanism 6 and the second electrolyte chamber 5 are sequentially connected. A negative ion exchange membrane 8 is provided between the first electrolyte chamber 4 and the buffer electrolyte mechanism 6, and a positive ion exchange membrane 9 is provided between the buffer electrolyte mechanism 6 and the second electrolyte chamber 5. During the discharging process of the charge-discharge battery, electrons flow from the anode 1 to the first cathode 2, the material of the anode in the first electrolyte chamber 4 loses electrons to obtain a first positive ion, and the electrolyte in the buffer electrolyte chamber 7 is ionized to obtain a first negative ion and H⁺. The material of the first cathode 2 in the second electrolyte chamber 5 obtains electrons to be bonded to H⁺. The first negative ion enters the first electrolyte chamber 4 through the negative ion exchange membrane 8, and H⁺ enters the second electrolyte chamber 5 through the positive ion exchange membrane 9 to be bonded to the material of the first cathode in place of the first positive ion. Therefore, during the discharging process, H⁺ is bonded to the material of the first cathode in place of the first positive ion, thereby effectively preventing the first positive ion generated at the anode 1 from migrating to the surface of the material of the first cathode 2. During the charging process, electrons flow from the first cathode 2 to the anode 1, molecules in the second electrolyte chamber 5 lose H+ obtained by electron decomposition, and the electrolyte in the first electrolyte chamber 4 is ionized to obtain a first positive ion and a first negative ion. The first positive ion accepts electrons to become the material of the anode, and H⁺ and the first negative ion enter the buffer electrolyte chamber 7 respectively through the positive ion exchange membrane 9 and the negative ion exchange membrane 8 and are bonded. Therefore, during the discharging process, the H⁺ generated in the second electrolyte chamber 5 is cleverly used to be bonded to the material of the first cathode 2 in place of the first positive ion generated from the material of the anode to combine into new molecules, and the buffer electrolyte chamber 7 is used to prevent the first positive ion from being mixed with H⁺, thereby avoiding generation of undesired material of the anode s during the charging process. According to the charge-discharge battery of the present utility model, metal ions generated at the anode 1 are prevented from being directly bonded to the cathode material, but instead the second positive ion H⁺ is used to be bonded to the cathode material, thereby expanding the selection range of materials of the cathode and the anode, reducing the cost of battery electrodes, improving the energy density of charge-discharge batteries, and extending the service life of charge-discharge batteries.

Further, the buffer electrolyte mechanism 6 comprises a plurality of buffer electrolyte chambers 7 that are sequentially connected in series. The positive ion exchange membrane 9 or the negative ion exchange membrane 8 is provided between respective buffer electrolyte chambers 7. The negative ion exchange membrane 8 is provided between the first buffer electrolyte chamber 7 and the first electrolyte chamber 4. The positive ion exchange membrane 9 is provided between the last buffer electrolyte chamber 7 and the second electrolyte chamber 5.

In the present utility model, the buffer electrolyte mechanism 6 specifically comprises a plurality of buffer electrolyte chambers 7 that are sequentially connected in series, and the positive ion exchange membrane 9 or the negative ion exchange membrane 8 is provided between respective buffer electrolyte chambers 7, that is, to allow the positive ion or the negative ion to pass through. The negative ion exchange membrane 8 is provided between the first buffer electrolyte chamber 7 and the first electrolyte chamber 4, thereby effectively avoiding the migration of metal ions generated from the material of the anode of the first electrolyte chamber 4. The positive ion exchange membrane 9 is provided between the last buffer electrolyte chamber 7 and the second electrolyte chamber 5, so as to implement free movement, between the last buffer electrolyte chamber 7 and the second electrolyte chamber 5, of the second positive ion H⁺ generated in the buffer electrolyte mechanism 7 or the second electrolyte chamber 5, so that the second positive ion H⁺ is bonded to the material of the first cathode 2 in place of metal ions generated by the material of the anode .

In the present utility model, different electrolytes can be provided in the plurality of buffer electrolyte chambers 7 according to specific use requirements, that is, metal ions different from the material of the anode can be generated by means of ionization, and battery diaphragms of different types are provided between adjacent buffer electrolyte chambers 7 to implement ion migration, and finally H⁺ is still bonded to the material of the cathode in place of metal ions generated by the material of the anode .

Further preferably, the buffer electrolyte mechanism 6 also comprises a hydrolysis neutralization chamber 10, and a second cathode 3 is provided in the hydrolysis neutralization chamber 10. The last buffer electrolyte chamber 7 is connected to the hydrolysis neutralization chamber 10, and a positive ion exchange membrane 9 is provided between the two. A negative ion exchange membrane 8 is provided between the hydrolysis neutralization chamber 10 and the second electrolyte chamber 5.

Specifically, the buffer electrolyte mechanism 6 also comprises a hydrolysis neutralization chamber 10, in which a second cathode 3 is provided. During the discharging process, electrons flow from the anode 1 to the first cathode 2. During the charging process, electrons flow from the second cathode 3 to the anode 1. The last buffer electrolyte chamber 7 is connected to the hydrolysis neutralization chamber 10, and a positive ion exchange membrane 9 is provided between the two, so that H⁺ generated in the buffer electrolyte chamber 7 can freely migrate to the hydrolysis neutralization chamber 10. A negative ion exchange membrane 8 is provided between the hydrolysis neutralization chamber 10 and the second electrolyte chamber 5, that is, negative ions in the first electrolyte chamber 4 can freely migrate to the hydrolysis neutralization chamber 10.

Further, the electrolyte in each buffer electrolyte chamber 7 is an acid solution that can ionize H⁺, preferably hydrogen chloride.

Optionally, the electrolyte in each buffer electrolyte chamber 7 is an acid solution that can ionize H⁺, preferably hydrogen chloride. In addition, the electrolyte in the buffer electrolyte chambers 7 can also be a solution that can ionize metal ions other than the anode 1.

Further preferably, the electrolyte in the second electrolyte chamber 5 is an alkali metal solution.

Specifically, the electrolyte in the second electrolyte chamber 5 is an alkali metal solution, for example, a solution such as sodium hydroxide that can ionize OH⁻.

More preferably, the material of the anode 1 is lithium metal; and the materials of the first cathode 2 and the second cathode 3 are both oxygen.

Specifically, in the present utility model, the material of the anode 1 is lithium metal, and the materials of the first cathode 2 and the second cathode 3 are both oxygen. The positive ion exchange membrane 9 is a fluorosulfuric acid proton-exchange membrane.

The present utility model further discloses a charge-discharge method for the charge-discharge battery mentioned above, the method comprising a discharging process and a charging process. During the discharging process, H⁺ is used in place of metal ions released from the anode to be bonded to the material of the cathode, and during the charging process, the buffer electrolyte mechanism 6 is used to prevent H⁺ from migrating to the first electrolyte chamber.

According to the charge-discharge method for the charge-discharge battery of the present utility model, metal ions generated from the anode 1 are prevented from being directly bonded to the material of the cathode, but instead the second positive ion H⁺ is used to be bonded to the material of the cathode, thereby expanding the selection range of materials of the cathode and the anode, reducing the cost of battery electrodes, improving the energy density of charge-discharge batteries, and extending the service life of charge-discharge batteries.

Further, the discharging process comprises: electrons flow from the anode 1 to the first cathode 2, and the material of the anode in the first electrolyte chamber 4 loses electrons to obtain a first positive ion. The electrolyte in the buffer electrolyte chamber 7 is ionized to obtain a first negative ion and H⁺. The material of the first cathode 2 in the second electrolyte chamber 5 obtains electrons to be bonded to H⁺. The first negative ion enters the first electrolyte chamber 4 through the negative ion exchange membrane 8, and H⁺ enters the second electrolyte chamber 5 through the positive ion exchange membrane 9 to be bonded to the material of the first cathode 2 in place of the first positive ion.

The charging process comprises: electrons flow from the first cathode 2 to the anode 1, molecules in the second electrolyte chamber 5 lose H+ obtained by electron decomposition, and the electrolyte in the first electrolyte chamber 4 is ionized to obtain a first positive ion and a first negative ion. The first positive ion accepts electrons to become the material of the anode, and H⁺ and the first negative ion enter the buffer electrolyte chamber 7 respectively through the positive ion exchange membrane 9 and the negative ion exchange membrane 8 and are bonded.

In the charge-discharge method, during the discharging process, electrons flow from the anode 1 to the first cathode 2, and the reaction that occurs in the first electrolyte chamber 4 is:

O₂+4H⁺+4e⁻=2H₂O+1.20 V

The material of the anode in the first electrolyte chamber 4 loses electrons to obtain a first positive ion. The electrolyte in the buffer electrolyte chamber 7 is ionized to obtain a first negative ion and H⁺. The material of the first cathode 2 in the second electrolyte chamber 5 obtains electrons to be bonded to H⁺. The first negative ion enters the first electrolyte chamber 4 through the negative ion exchange membrane 8, and H⁺ enters the second electrolyte chamber 5 through the positive ion exchange membrane 9 to be bonded to the material of the first cathode 2 in place of the first positive ion.

During the charging process, electrons flow from the first cathode 2 to the anode 1, molecules in the second electrolyte chamber 5 lose H+ obtained by electron decomposition, and the electrolyte in the first electrolyte chamber 4 is ionized to obtain a first positive ion and a first negative ion. The first positive ion accepts electrons to become the material of the anode, and H⁺ and the first negative ion enter the buffer electrolyte chamber 7 respectively through the positive ion exchange membrane 9 and the negative ion exchange membrane 8 and are bonded.

Further, the discharging process comprises: electrons flow from the anode 1 to the first cathode 2, and the material of the anode in the first electrolyte chamber 4 loses electrons to obtain a first positive ion. The electrolyte in the buffer electrolyte chamber 7 is ionized to obtain a first negative ion and H⁺. The material of the first cathode 2 in the second electrolyte chamber 5 obtains electrons to generate OH⁻. H⁺ and OH⁻ respectively enter the hydrolysis neutralization chamber 10 through the positive ion exchange membrane 9 and the negative ion exchange membrane 8 to generate water molecules, and the first negative ion enters the first electrolyte chamber 4 through the negative ion exchange membrane 8 to be bonded to the first positive ion.

The charging process comprises: electrons flow from the second cathode 3 to the anode 1, and molecules in the hydrolysis neutralization chamber 10 lose electrons to obtain H⁺. The electrolyte in the first electrolyte chamber 4 is ionized to obtain a first positive ion and a first negative ion. The first positive ion accepts electrons to become the material of the anode, and H⁺ and the first negative ion enter the buffer electrolyte chamber 7 respectively through the positive ion exchange membrane 9 and the negative ion exchange membrane 8 and are bonded.

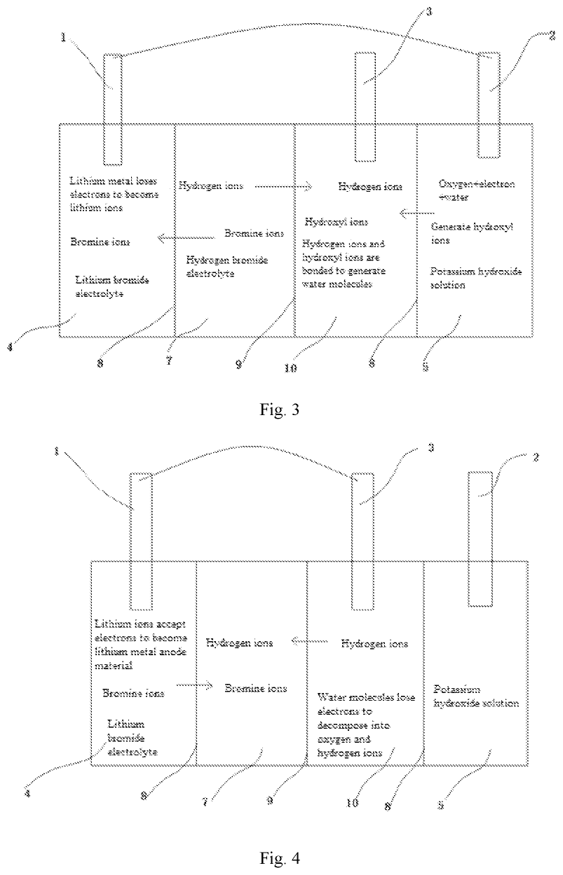

As shown in FIGS. 3-4, in the charge-discharge method, during the discharging process, electrons flow from the anode 1 to the first cathode 2, and the reaction that occurs in the first electrolyte chamber 4 is:

O₂+H₂O4e⁻=4OH⁻+0.40 V

The material of the anode 1 in the first electrolyte chamber 4 loses electrons to obtain a first positive ion. The electrolyte in the buffer electrolyte chamber 7 is ionized to obtain a first negative ion and H⁺. The material of the first cathode 2 in the second electrolyte chamber 5 obtains electrons to generate OH⁻. H⁺ and OH⁻ respectively enter the hydrolysis neutralization chamber 10 through the positive ion exchange membrane 9 and the negative ion exchange membrane 8 to generate water molecules, and the first negative ion enters the first electrolyte chamber 4 through the negative ion exchange membrane 8 to be bonded to the first positive ion.

During the charging process, electrons flow from the second cathode 3 to the anode 1, and molecules in the hydrolysis neutralization chamber 10 lose electrons to obtain H⁺. The electrolyte in the first electrolyte chamber 4 is ionized to obtain a first positive ion and a first negative ion. The first positive ion accepts electrons to become the material of the anode, and H⁺ and the first negative ion enter the buffer electrolyte chamber 7 respectively through the positive ion exchange membrane 9 and the negative ion exchange membrane 8 and are bonded.

In the present specific embodiments, the material of the anode 1 is lithium metal, the material of the first cathode is oxygen, the first positive ion is a lithium ion, and the second positive ion is H⁺.

During the discharging process, oxygen molecules of the material of the first cathode 2 accept electrons and react with water to generate OH⁻, and H⁺ enters the second electrolyte chamber 5 through the buffer electrolyte chamber 7 to be bonded to OH⁻ to generate water molecules.

O₂+H₂O+4e⁻=4OH⁻+0.40 V

In a lithium-air battery in the prior art, lithium ions and oxygen are directly bonded to generate lithium oxides, which however, are highly unstable, resulting in the cathode material having low charging efficiency during charging and short service life. The charge-discharge battery in the present utility model completely solves the problem. In addition, a metal-air battery in the prior art will react with carbon dioxide in air to generate carbonate ions, to further generate a metal carbonate compound to stop continuing the reaction. In the design of the present utility model, metal ions and carbonate ions are isolated by means of a battery diaphragm, thereby avoiding the generation of a metal carbonate compound.

During the discharging process, the following reaction can also be generated in the second electrolyte chamber 5:

O₂+4H⁺+4e⁻2=H₂O+1.20 V

H⁺ enters the second electrolyte chamber 5 from the buffer electrolyte chamber 7 to react with oxygen and electrons to generate water molecules.

In the present utility model, to verify the charge-discharge effect of the designed novel charge-discharge battery, a test for energy density is performed on the charge-discharge battery designed in the solution mentioned above. The test result is shown in Table 1.

TABLE 1
Energy density of the charge-discharge battery
designed in the solution mentioned above

| | | | Energy |
|---|---|---|---|
| | anode 1 | First cathode 2 | density wh/kg |
| Embodiment 1 | Lithium | Oxygen | 1150 |

It can be seen from Table 1 that, the energy density of the charge-discharge battery prepared in Embodiment 1 of the present utility model is significantly increased. Therefore, the charge-discharge battery in the present utility model reduces the cost of battery electrodes, improves the energy density of rechargeable batteries, and extends the service life of batteries. Finally, it should be noted that the respective embodiments mentioned above are merely used to illustrate the technical solutions of the present utility model, but not to limit them. Although the present utility model has been described in detail with reference to the embodiments mentioned above, a person of ordinary skill in the art should understand that the technical solutions described in the respective embodiments mentioned above can still be modified, or some or all of the technical features thereof can be equivalently replaced, and these modifications or replacements do not make the essence of the corresponding technical solutions depart from the scope of the technical solutions of the embodiments of the present invention.

1. A high energy density charge-discharge battery, comprising: an anode (1), a first cathode (2), a first electrolyte chamber (4), a second electrolyte chamber (5) and a buffer electrolyte mechanism (6), wherein
one end of the anode (1) is arranged in the first electrolyte chamber (4), and one end of the first cathode (2) is arranged in the second electrolyte chamber (5); and
the first electrolyte chamber (4), the buffer electrolyte mechanism (6) and the second electrolyte chamber (5) are sequentially connected, a first ion exchange membrane is provided between the first electrolyte chamber (4) and the buffer electrolyte mechanism (6), and a second ion exchange membrane with opposite polarity to the first ion exchange membrane is provided between the buffer electrolyte mechanism (6) and the second electrolyte chamber (5).

2. The charge-discharge battery according to claim 1, wherein the buffer electrolyte mechanism (6) comprises a plurality of buffer electrolyte chambers (7) that are sequentially connected in series;
one side of each buffer electrolyte chamber (7) is also provided with the first ion exchange membrane, and the other side of each buffer electrolyte chamber (7) is also provided with the second ion exchange membrane;
the first buffer electrolyte chamber (7) and the first electrolyte chamber (4) are connected by means of the first ion exchange membrane, and the first ion exchange membrane is a negative ion exchange membrane (8); and
the last buffer electrolyte chamber (7) and the second electrolyte chamber (5) are connected by means of the second ion exchange membrane, and the second ion exchange membrane is a positive ion exchange membrane (9).

3. The charge-discharge battery according to claim 2, wherein the buffer electrolyte mechanism (6) further comprises a hydrolysis neutralization chamber (10), and a second cathode (3) is provided in the hydrolysis neutralization chamber (10);
the last buffer electrolyte chamber (7) is connected to the hydrolysis neutralization chamber (10), and the positive ion exchange membrane (9) is provided between the two; and
the negative ion exchange membrane (8) is provided between the hydrolysis neutralization chamber (10) and the second electrolyte chamber (5).

4. The charge-discharge battery according to claim 2, wherein the electrolyte in each buffer electrolyte chamber (7) is an acidic solution that can ionize H⁺.

5. The charge-discharge battery according to claim 1, wherein the electrolyte in the second electrolyte chamber (5) is an alkali metal solution.

6. The charge-discharge battery according to claim 1, wherein the material of the anode (1) is lithium metal.

7. The charge-discharge battery according to claim 3, wherein the materials of the first cathode (2) and the second cathode (3) are both oxygen.

8. The charge-discharge battery according to claim 2, wherein the positive ion exchange membrane (9) is a fluorosulfuric acid proton exchange membrane.
